(19) United States
(12) Patent Application Publication
(10) Pub. No.: US 2026/0280375 A1
(43) Pub. Date: Sep. 17, 2026

(54) ROTATING ELECTRIC MACHINE SYSTEM

(71) Applicant: HONDA MOTOR CO., LTD., Tokyo (JP)

(72) Inventors: Yudai Hirose, Wako-shi (JP); Manabu Yatsurugi, Wako-shi (JP); Manabu Yazaki, Wako-shi (JP)

(21) Appl. No.: 19/568,182

(22) Filed: Mar. 16, 2026

(30) Foreign Application Priority Data
Mar. 17, 2025 (JP) 2025-042182

(51) Int. Cl. H02K 3/28; H02K 3/34

(52) U.S. Cl. CPC H02K 3/28; H02K 3/34; H02K 2203/09

(57) ABSTRACT

A stator of a rotating electric machine includes a plurality of coil units. Each of the plurality of coil units includes a conductive wire bundling portion in which end parts of a plurality of conductive wires are bundled together and connected. The rotating electric machine includes a neutral point bus bar, and a plurality of conductive bus bars. When one end part in an axial direction of the rotating shaft is viewed from the axial direction, the neutral point bus bar, the plurality of conductive wire bundling portions, and the plurality of conductive bus bars are aligned in this order from inwardly toward outwardly in a radial direction of a rotating shaft.

### CROSS-REFERENCE TO RELATED APPLICATIONS

This application is based upon and claims the benefit of priority from Japanese Patent Application No. 2025-042182 filed on Mar. 17, 2025, the contents of which are incorporated herein by reference.

### BACKGROUND OF THE INVENTION

### Field of the Invention

The present disclosure relates to a rotating electric machine system.

### Description of the Related Art

As is well known, a rotating electric machine includes a stator and a connector portion. The stator includes an electromagnetic coil, and the connector portion includes a terminal. In the rotating electric machine described in JP 2009-247058 A, the electromagnetic coils of each of respective phases are electrically connected to the terminals of each of the phases via a bus ring. Furthermore, in such a rotating electric machine, neutral points of the electromagnetic coils of each of the phases are connected by a neutral point bus ring.

### SUMMARY OF THE INVENTION

As can be understood from the above, the rotating electric machine has a large number of electrical connection points. For this reason, the assembly work of the rotating electric machine is complicated.

The present invention has the object of solving the aforementioned problem.

An aspect of the present disclosure is characterized by a rotating electric machine system provided with a rotating electric machine including a rotor including a rotating shaft, a stator including a plurality of coil units, and a connector including a plurality of terminals configured to electrically connect the plurality of coil units to an external device, and a rotating electric machine housing on which the rotating shaft is rotatably supported, wherein the stator includes a stator core, each of the plurality of coil units includes a plurality of coil portions formed by winding a plurality of conductive wires respectively around the stator core, and a conductive wire bundling portion in which end parts of the plurality of conductive wires are bundled together and connected, the rotating electric machine includes a neutral point bus bar configured to be electrically connected to neutral points of the plurality of coil units, and a plurality of conductive bus bars configured to electrically connect, respectively, the plurality of conductive wire bundling portions and the plurality of terminals, and the neutral point bus bar, the plurality of conductive wire bundling portions, and the plurality of conductive bus bars, when one end part in the axial direction of the rotating shaft is viewed from the axial direction, are aligned in this order from inwardly toward outwardly in the radial direction of the rotating shaft, and further, when the rotating shaft is viewed from a direction perpendicular to the axial direction, are aligned in this order in the axial direction from an intermediate portion of the rotating shaft in the axial direction toward the one end part.

According to the present disclosure, the work of providing an electrical connection portion in the rotating electric machine is easy. In accordance therewith, the working efficiency and the reliability in assembling the rotating electric machine system is improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic perspective view of a combined motive power system;

FIG. 2 is a schematic cross-sectional side view of the rotating electric machine system as viewed from a direction perpendicular to the axial direction of a rotating shaft;

FIG. 3 is a schematic perspective view showing a connection pattern between a plurality of coil units and a neutral point bus bar;

FIG. 4 is a schematic perspective view showing a connection pattern between a U-phase coil unit and the neutral point bus bar;

FIG. 5 is a schematic perspective view showing a connection pattern between a V-phase coil unit and the neutral point bus bar;

FIG. 6 is a schematic perspective view showing a connection pattern between a W-phase coil unit and the neutral point bus bar;

FIG. 7 shows an equivalent circuit formed by the U-phase coil unit, the V-phase coil unit, the W-phase coil unit, and the neutral point bus bar;

FIG. 8 is a schematic perspective view of an electrical connection portion when viewed from one end in the axial direction of the rotating shaft;

FIG. 9 is an enlarged view of a main part in the vicinity of the electrical connection portion;

FIG. 10 is an enlarged view of a main part in the vicinity of a bus rod which serves as a terminal; and

FIG. 11 is an enlarged view of a main part in the vicinity of the bus rod when thermal expansion has occurred.

### DETAILED DESCRIPTION OF THE INVENTION

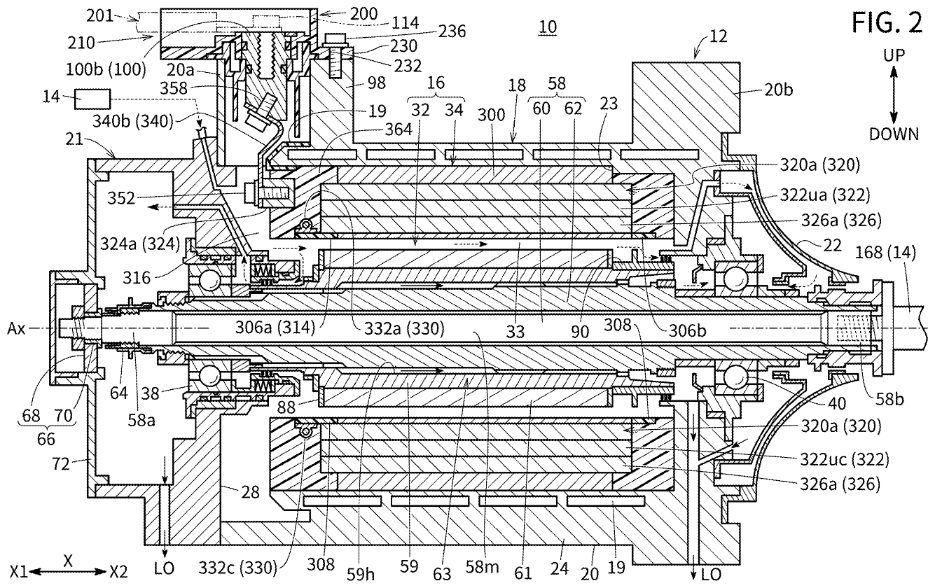

Hereinafter, a description will be given concerning an embodiment in which a rotating electric machine 16 shown in FIG. 2 is a three-phase electrical generator. However, this embodiment is an exemplary illustration in order to simplify the description and to facilitate understanding. The rotating electric machine 16 may be a single phase or a two-phase electrical generator, or may be an electrical generator having four or more phases. Further, the rotating electric machine 16 may be a motor.

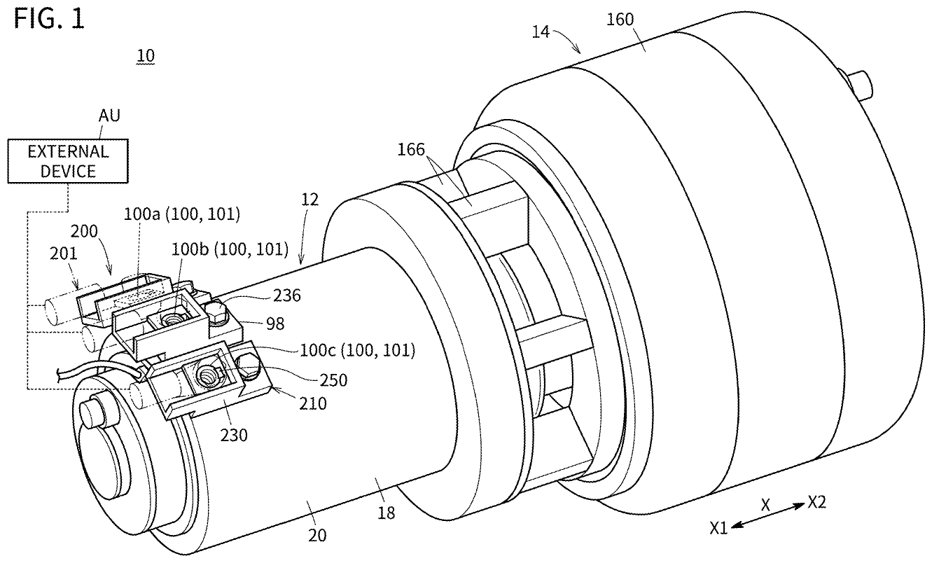

A combined motive power system 10 shown in FIG. 1 is equipped with a rotating electric machine system 12 according to the present embodiment, and a gas turbine engine 14 which is an internal combustion engine. An axial line of the rotating electric machine system 12, and an axial line of the gas turbine engine 14 coincide with each other. Stated otherwise, the rotating electric machine system 12 and the gas turbine engine 14 are arranged in series on the same axial line.

The combined motive power system 10 is used, for example, as a motive power source for providing propulsion in a flying object, a ship, an automobile, or the like. Suitable specific examples of the flying object include drones and multi-copters. The combined motive power system 10, when mounted on a flying object, is used as a power drive source for rotationally driving, for example, a prop, a ducted fan, or the like. The combined motive power system 10, when mounted on a ship, is used as a screw rotational force generating device. The combined motive power system 10, when mounted on an automobile, is used as a power drive source for rotating a motor.

The combined motive power system 10 can also be used as an auxiliary electrical power source in an aircraft, a ship, a building, or the like. Apart therefrom, it is also possible to utilize the combined motive power system 10 as gas turbine power generation equipment.

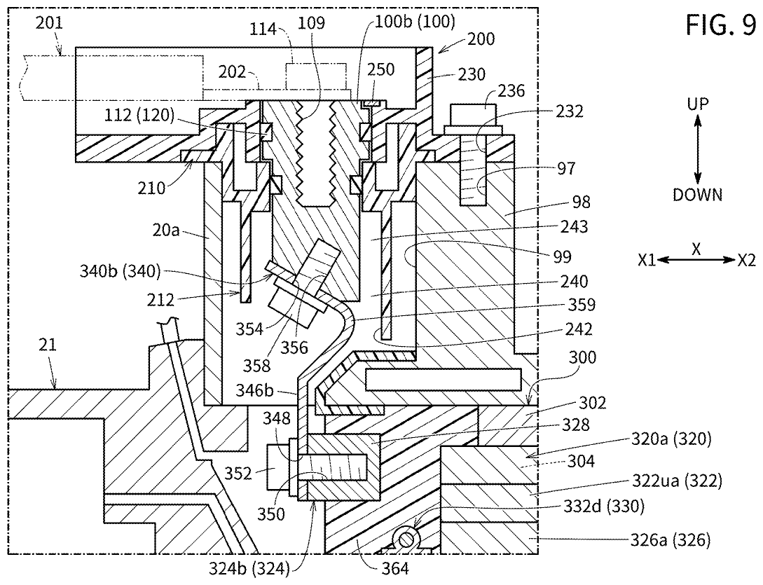

In the following description, the respective terms “lower” and “upper” refer specifically to the lower and the upper directions shown in FIG. 2 and FIG. 9. Furthermore, unless otherwise specified, the terms “axial direction,” “circumferential direction,” and “radial direction” refer respectively to the axial direction, the circumferential direction, and the radial direction of a rotating shaft 58 shown in FIG. 2. However, the axial direction, the circumferential direction, and the radial direction of the rotating shaft 58 may also be respectively referred to as “an axial direction of the rotating shaft 58,” “a circumferential direction of the rotating shaft 58,” and “a radial direction of the rotating shaft 58.” The reason therefore is in order to avoid confusion with the axial direction, the circumferential direction, and the radial direction of other members.

As shown in FIG. 2, the rotating electric machine system 12 is equipped with the rotating electric machine 16, and a rotating electric machine housing 18.

The rotating electric machine housing 18 accommodates the rotating electric machine 16. The rotating electric machine housing 18 includes a main housing 20, a first sub-housing 21, and a second sub-housing 22. The main housing 20 has a substantially cylindrical shape both ends of which are open. The main housing 20 includes an accommodation chamber 28 that serves to accommodate the rotating electric machine 16. A cooling jacket 19 is formed in the interior of a circumferential wall part 24 of the main housing 20. A liquid coolant such as cooling water or the like flows through the cooling jacket 19.

The first sub-housing 21 is connected to a first housing end 20a, which is an end part on a side in the X1 direction of the main housing 20, and thereby closes an opening of the first housing end 20a. The second sub-housing 22 is connected to a second housing end 20b, which is an end part on a side in the X2 direction of the main housing 20, and thereby closes an opening of the second housing end 20b.

In the present embodiment, the rotating electric machine 16 is a generator. The rotating electric machine 16 includes a rotor 32 and a stator 34. The rotor 32 is supported via a first bearing 38 and a second bearing 40 to be capable of rotating with respect to the rotating electric machine housing 18. A lubricating oil LO is supplied in a circulating manner from a non-illustrated oil circulation supply device to the first bearing 38 and the second bearing 40.

The rotor 32 includes the rotating shaft 58, a sleeve 59, and permanent magnets 61. The sleeve 59 surrounds the rotating shaft 58, and the permanent magnets 61 surround the sleeve 59. A rotor internal flow path 63 is formed in the rotor 32. A liquid coolant flows through the rotor internal flow path 63. The liquid coolant, for example, is a branched flow of the lubricating oil LO that is supplied from the oil circulation supply device. The lubricating oil LO flows in the X2 direction through the rotor internal flow path 63.

The rotating shaft 58 is supported to be capable of rotating by the first sub-housing 21 via the first bearing 38, and further, is supported to be capable of rotating by the main housing 20 via the second bearing 40. The rotating shaft 58 includes a central axis Ax, an inner shaft 60, and an outer shaft 62. In the axial direction of the rotating shaft 58, an X1 side end part of the inner shaft 60 is exposed from an X1 side end part of the outer shaft 62. The X1 side end part of the inner shaft 60 and the X1 side end part of the outer shaft 62 are connected by a fixing structure including a nut member 64 and the like.

A resolver rotor 70 is fixed to the X1 side end part of the inner shaft 60. A resolver stator 68 is disposed in a manner so as to surround the resolver rotor 70. The resolver stator 68 is retained by a resolver holder 72 that is attached to the first sub-housing 21. The resolver rotor 70 and the resolver stator 68 constitute a resolver 66.

Hereinafter, the X1 side end part of the rotating shaft 58 will be referred to as a first shaft end 58a, and an X2 side end part of the rotating shaft 58 will be referred to as a second shaft end 58b. Further, the area between the first shaft end 58a and the second shaft end 58b is defined as an intermediate portion 58m. The aforementioned fixing structure is disposed on the first shaft end 58a.

As shown in FIG. 2, the sleeve 59 is a hollow cylindrical member having an inner hole 59h. The rotating shaft 58 is inserted into the inner hole 59h of the sleeve 59. A major portion of the rotor internal flow path 63 is formed by the sleeve 59 and the rotating shaft 58. The sleeve 59 surrounds the rotating shaft 58.

The sleeve 59 is fixed, for example, by shrink fitting, to an outer surface of the rotating shaft 58. The permanent magnets 61 are retained in the sleeve 59. The permanent magnets 61 are fixed to an outer circumferential surface of the sleeve 59 by a first magnet stopper 88 and a second magnet stopper 90. In the illustrated example, the rotor 32 is a so-called SPM (surface permanent magnet) type in which the permanent magnets 61 are disposed on the outer circumferential surface of the sleeve 59. Alternatively, the rotor 32 may be a so-called IPM (interior permanent magnet) type in which the permanent magnets 61 are embedded in the sleeve 59.

The stator 34 includes a stator core 300. The stator core 300 includes a cylindrical shaped yoke portion, and a plurality of teeth portions that are projected out inwardly in the radial direction from an inner circumferential surface of the yoke portion. The stator core 300, for example, is constituted by stacking along the axial direction a plurality of thin electromagnetic steel plates. An individual one of the thin electromagnetic steel plates integrally includes a yoke portion and a plurality of teeth portions. Hereinafter, an aspect in which the number of the plurality of teeth is twelve individual teeth will be exemplified. However, the number of the teeth portions is not necessarily limited to twelve individual teeth portions. Moreover, since the configuration of this type of the stator core 300 is well known, illustration of the yoke portion and the teeth portions is omitted.

The stator core 300 extends along the axial direction. A first insulator 306a and a second insulator 306b are respectively disposed on the X1 side end part and the X2 side end part of the yoke portion. Each of the first insulator 306a and the second insulator 306b includes an inner circumferential protruding part 308, a non-illustrated outer circumferential protruding part, and a non-illustrated relay portion. The relay portion extends along the radial direction of the rotating shaft 58. The inner circumferential protruding part 308 projects out along the axial direction from an inner circumferential side end part of the relay portion. The outer circumferential protruding part projects out along the axial direction from an outer circumferential side end part of the relay portion. The protruding length of the outer circumferential protruding part is slightly smaller than the protruding length of the inner circumferential protruding part 308. The relay portion serves to connect the inner circumferential protruding part 308 and the outer circumferential protruding part.

As shown in FIG. 2, the rotating electric machine 16 comprises a partition member 314. The interior of the rotating electric machine housing 18 is divided by the partition member 314 into a rotor accommodating chamber 33 in which the rotor 32 is accommodated, and a connection portion accommodation chamber 316 in which an electrical connection portion is accommodated. The electrical connection portion includes a later-described neutral point bus bar 330. As can be understood from this feature, the partition member 314 is interposed between the rotating shaft 58 and the neutral point bus bar 330, and serves to separate the rotating shaft 58 from the neutral point bus bar 330.

In the present embodiment, the partition member 314 (particularly, the inner circumferential protruding part 308 thereof) is the first insulator 306a. However, the partition member 314 may be a separate member that is separate from the first insulator 306a.

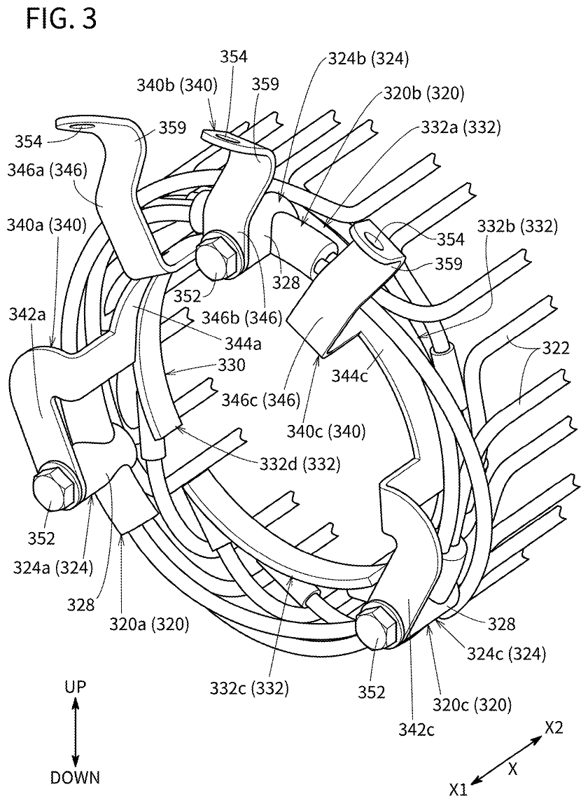

As shown in FIG. 3, the stator 34 comprises a plurality of coil units 320. Each of the plurality of coil units 320 includes a plurality of conductive wires 322, and a conductive wire bundling portion 324. A plurality of coil portions 326 (refer to FIG. 2) are formed by respectively winding the plurality of conductive wires 322 respectively around the teeth portions. The method of winding the conductive wires, for example, is concentrated winding. The method of winding may also be distributed winding. The plurality of coil portions 326 are also wound around the respective relay portions of the first insulator 306a and the second insulator 306b.

The conductive wire bundling portion 324 is formed by bundling and connecting end parts of the plurality of conductive wires 322. The conductive wire bundling portion 324 comprises a connection terminal 328. On the other hand, the plurality of conductive wires 322 are electrically connected to the neutral point bus bar 330. This point will be discussed later.

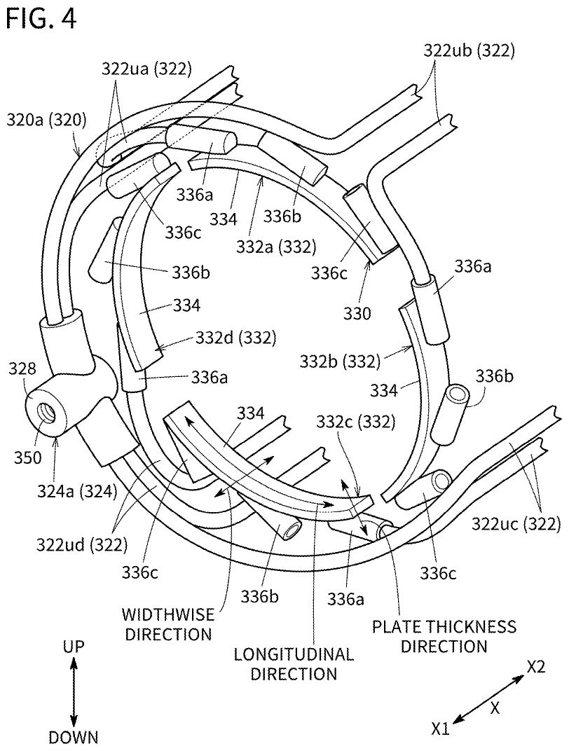

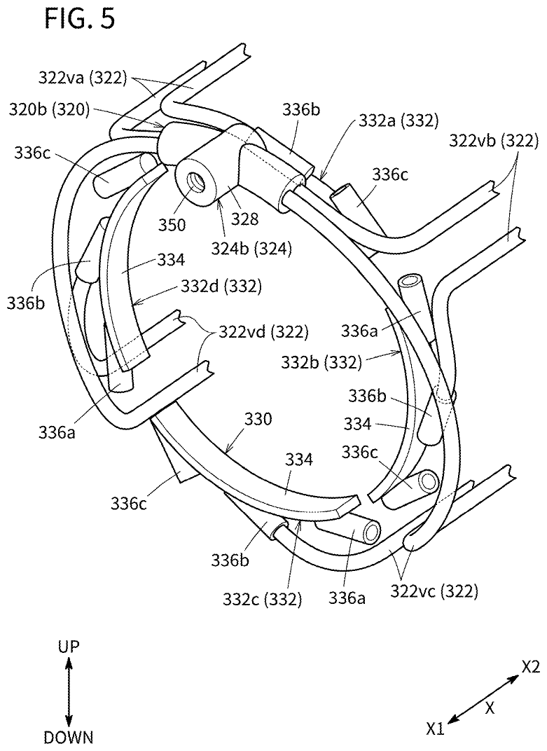

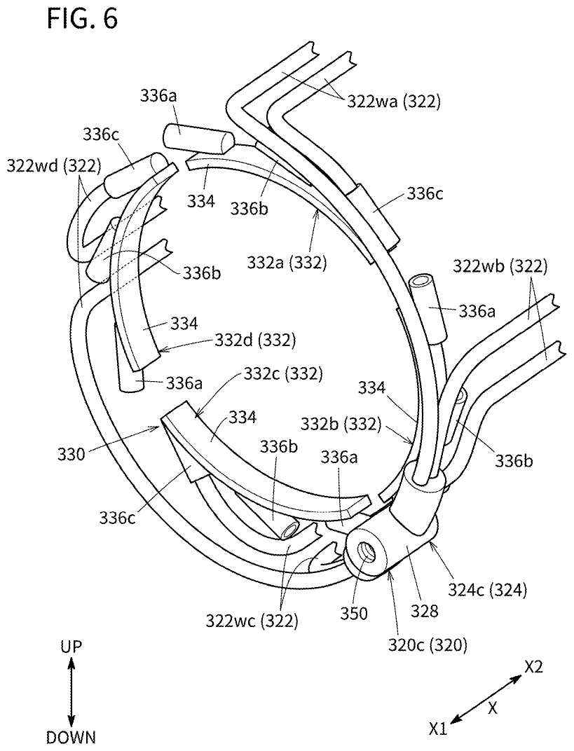

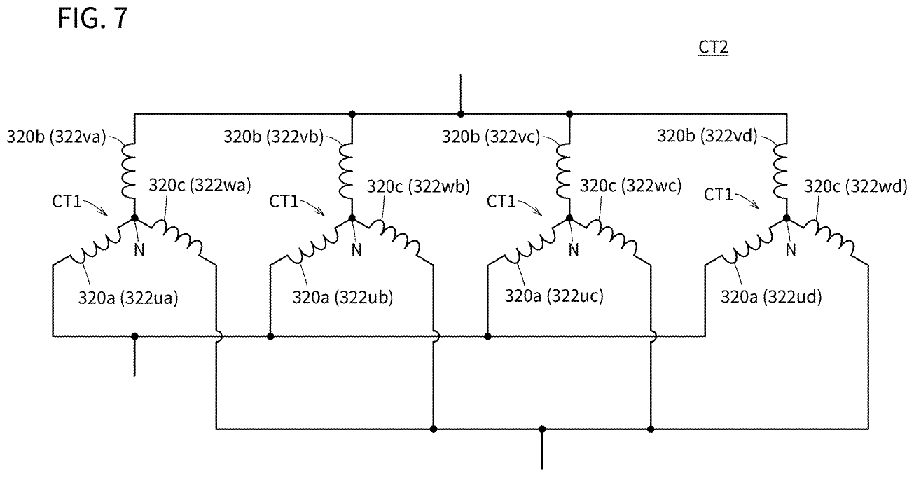

As noted previously, in the present embodiment, the rotating electric machine 16 is a three-phase generator. Therefore, the plurality of coil units 320 include a U-phase coil unit 320a, a V-phase coil unit 320b, and a W-phase coil unit 320c. As shown in FIG. 2 and FIG. 4, the coil portion 326 and the conductive wire bundling portion 324 in the U-phase coil unit 320a are respectively referred to as a “U-phase coil portion 326a” and a “U-phase conductive wire bundling portion 324a.” As shown in FIG. 7 and FIG. 5, the coil portion 326 and the conductive wire bundling portion 324 in the V-phase coil unit 320b are respectively referred to as a “V-phase coil portion 326b” and a “V-phase conductive wire bundling portion 324b.” As shown in FIG. 7 and FIG. 6, the coil portion 326 and the conductive wire bundling portion 324 in the W-phase coil unit 320c are respectively referred to as a “W-phase coil portion 326c” and a “W-phase conductive wire bundling portion 324c.”

FIG. 4 is a schematic perspective view showing a connection pattern between the U-phase coil unit 320a and the neutral point bus bar 330. Moreover, in FIG. 4, illustration of the V-phase coil unit 320b and the W-phase coil unit 320c is omitted. In the U-phase coil unit 320a, the number of the conductive wires 322 is a number obtained by dividing the number of the teeth portions by the number of the phases. In the aspect shown in FIG. 3 to FIG. 6, the number of the teeth portions is twelve, and the rotating electric machine 16 is a three-phase generator. Accordingly, the U-phase coil unit 320a includes four individual ones of the conductive wires 322. Hereinafter, in order to distinguish between them, the four individual conductive wires 322 will be referred to respectively as a first U-phase conductive wire 322ua, a second U-phase conductive wire 322ub, a third U-phase conductive wire 322uc, and a fourth U-phase conductive wire 322ud.

The four individual U-phase coil portions 326a are formed respectively by winding the first U-phase conductive wire 322ua, the second U-phase conductive wire 322ub, the third U-phase conductive wire 322uc, and the fourth U-phase conductive wire 322ud around the four individual teeth portions. Further, in the U-phase conductive wire bundling portion 324a, respective end parts of the first U-phase conductive wire 322ua, the second U-phase conductive wire 322ub, the third U-phase conductive wire 322uc, and the fourth U-phase conductive wire 322ud are bundled together.

As shown in FIG. 5, the V-phase coil unit 320b includes four individual ones of the conductive wires 322 in a similar manner to the above-mentioned structure. Hereinafter, in order to distinguish between them, the four individual conductive wires 322 will be referred to respectively as a first V-phase conductive wire 322va, a second V-phase conductive wire 322vb, a third V-phase conductive wire 322vc, and a fourth V-phase conductive wire 322vd. The four individual V-phase coil portions 326b are formed respectively by winding the first V-phase conductive wire 322va, the second V-phase conductive wire 322vb, the third V-phase conductive wire 322vc, and the fourth V-phase conductive wire 322vd around four individual teeth portions different from the aforementioned four individual teeth portions.

Furthermore, as shown in FIG. 6, the W-phase coil unit 320c includes four individual ones of the conductive wires 322 in a similar manner to the above-mentioned structure. Hereinafter, in order to distinguish between them, the four individual conductive wires 322 will be referred to respectively as a first W-phase conductive wire 322wa, a second W-phase conductive wire 322wb, a third W-phase conductive wire 322wc, and a fourth W-phase conductive wire 322wd. The four individual W-phase coil portions 326c are formed respectively by winding the first W-phase conductive wire 322wa, the second W-phase conductive wire 322wb, the third W-phase conductive wire 322wc, and the fourth W-phase conductive wire 322wd around four individual teeth portions different from the aforementioned total eight individual teeth portions.

As shown in FIG. 3 to FIG. 6, the rotating electric machine 16 includes the neutral point bus bar 330. Other ends of the U-phase coil unit 320a, the V-phase coil unit 320b, and the W-phase coil unit 320c are electrically connected to the neutral point bus bar 330.

In the present embodiment, the neutral point bus bar 330 includes a plurality of bus bar segments 332. The number of the bus bar segments 332 is the same as the number of the conductive wires 322 in each of the U-phase coil unit 320a, the V-phase coil unit 320b, and the W-phase coil unit 320c. More specifically, in the illustrated embodiment, the number of the bus bar segments 332 is four. Hereinafter, in order to distinguish between them, the four individual bus bar segments 332 will be referred to respectively as a first bus bar segment 332a, a second bus bar segment 332b, a third bus bar segment 332c, and a fourth bus bar segment 332d. The first bus bar segment 332a, the second bus bar segment 332b, the third bus bar segment 332c, and the fourth bus bar segment 332d are disposed in an annular shape.

Each of the first bus bar segment 332a, the second bus bar segment 332b, the third bus bar segment 332c, and the fourth bus bar segment 332d comprises a main body portion 334, a first connecting portion 336a, a second connecting portion 336b, and a third connecting portion 336c. The main body portion 334 is formed from a plate material that is curved in an arcate shape. An inner circumferential surface of the main body portion 334 abuts against an outer circumferential surface of the inner circumferential protruding part 308 of the first insulator 306a. The first connecting portion 336a, the second connecting portion 336b, and the third connecting portion 336c are mutually disposed at a distance from one another on the outer circumferential surface of the main body portion 334.

As shown in FIG. 4, in the first bus bar segment 332a, a plate thickness direction of the main body portion 334 is oriented along the radial direction. The longitudinal direction of the main body portion 334 is oriented along the circumferential direction. In the main body portion 334, a direction perpendicular to the plate thickness direction and the longitudinal direction is a widthwise direction. The widthwise direction is parallel with respect to the axial direction. Concerning the second bus bar segment 332b, the third bus bar segment 332c, and the fourth bus bar segment 332d as well, the same features apply thereto.

As can be understood with reference to FIG. 3 to FIG. 6, the first U-phase conductive wire 322ua is connected to the first connection portion 336a of the first bus bar segment 332a. The first V-phase conductive wire 322va and the first W-phase conductive wire 322wa are respectively connected to the second connecting portion 336b and the third connecting portion 336c. The second U-phase conductive wire 322ub, the second V-phase conductive wire 322vb, and the second W-phase conductive wire 322wb are respectively connected to the first connecting portion 336a, the second connecting portion 336b, and the third connecting portion 336c in the second bus bar segment 332b.

Similarly, the third U-phase conductive wire 322uc, the third V-phase conductive wire 322vc, and the third W-phase conductive wire 322wc are respectively connected to the first connecting portion 336a, the second connecting portion 336b, and the third connecting portion 336c in the third bus bar segment 332c. Furthermore, the fourth U-phase conductive wire 322ud, the fourth V-phase conductive wire 322vd, and the fourth W-phase conductive wire 322wd are respectively connected to the first connecting portion 336a, the second connecting portion 336b, and the third connecting portion 336c in the fourth bus bar segment 332d.

In this manner, the neutral point bus bar 330 serves as an electrical connection portion. Further, the U-phase conductive wire bundling portion 324a, the V-phase conductive wire bundling portion 324b, and the W-phase conductive wire bundling portion 324c also serve as electrical connection portions. The neutral point bus bar 330, the U-phase conductive wire bundling portion 324a, the V-phase conductive wire bundling portion 324b, and the W-phase conductive wire bundling portion 324c are positioned in the connection portion accommodation chamber 316.

FIG. 7 shows an equivalent circuit formed by the U-phase coil unit 320a, the V-phase coil unit 320b, and the W-phase coil unit 320c. The U-phase coil unit 320a, the V-phase coil unit 320b, and the W-phase coil unit 320c form a so-called four-parallel Y-connection circuit CT2 having four individual single circuits CT1. As noted previously, the neutral point bus bar 330 includes the first bus bar segment 332a to the fourth bus bar segment 332d (refer to FIG. 3 to FIG. 6). Therefore, as shown in FIG. 7, the neutral points N themselves of the respective individual single circuits CT1 are not electrically connected to each other.

As shown in FIG. 1, a terminal casing 98 that constitutes a connector portion 200 is integrally provided on an upper outer surface on a side in the X1 direction of the main housing 20. The connector portion 200 includes a plurality of terminals 101. Each of the plurality of terminals 101 is constituted from a bus rod 100. The bus rods 100 are rod shaped or columnar shaped conductive bodies. A cross section of the bus rods 100 in a direction perpendicular to the axial direction, for example, is circular shaped. The cross section may also be polygonal shaped.

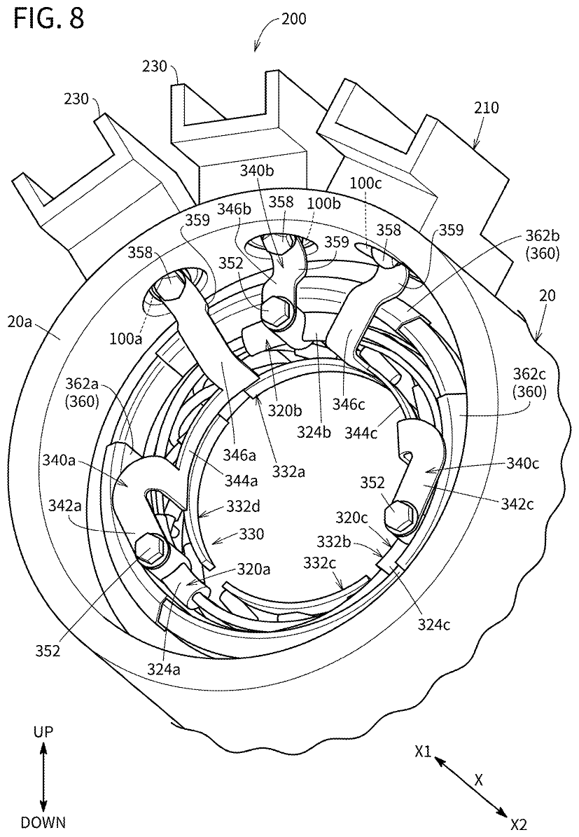

The bus rods 100 are accommodated inside the terminal casing 98. As shown in FIG. 8, the axial direction of each of the bus rods 100 is substantially parallel to the radial direction of the rotating shaft 58. Stated otherwise, each of the bus rods 100 is in a posture that extends along the radial direction of the rotating shaft 58.

Hereinafter, in order to distinguish between them, the U-phase bus rod 100 will be referred to as a U-phase bus rod 100a. The V-phase bus rod 100 will be referred to as a V-phase bus rod 100b, and the W-phase bus rod 100 will be referred to as a W-phase bus rod 100c. However, there are cases in which the U-phase bus rod 100a, the V-phase bus rod 100b, and the W-phase bus rod 100c may be collectively referred to as “bus rods 100.” The U-phase bus rod 100a, the V-phase bus rod 100b, and the W-phase bus rod 100c, respectively, are a U-phase terminal, a V-phase terminal, and a W-phase terminal.

The U-phase bus rod 100a, the V-phase bus rod 100b, and the W-phase bus rod 100c are electrically connected, respectively, to the U-phase coil unit 320a (refer to FIG. 2 to FIG. 4), the V-phase coil unit 320b (refer to FIG. 3 and FIG. 5), and the W-phase coil unit 320c (refer to FIG. 3 and FIG. 6) of the stator 34. Concerning such a configuration, a detailed description thereof will be given below.

As shown in FIG. 3 and FIG. 8, the rotating electric machine 16 includes a plurality of conductive bus bars 340. The plurality of conductive bus bars 340 include a U-phase conductive bus bar 340a, a V-phase conductive bus bar 340b, and a W-phase conductive bus bar 340c. The U-phase conductive bus bar 340a includes a U-phase tongue portion 342a, a U-phase circumferential extending portion 344a, and a U-phase radially extending portion 346a. The U-phase circumferential extending portion 344a extends along the circumferential direction. The U-phase tongue portion 342a is continuous, with respect to a lower end of the U-phase circumferential extending portion 344a, in a manner so as to project out toward the X1 direction. The plate thickness direction of the U-phase tongue portion 342a is substantially perpendicular to the plate thickness direction of the U-phase circumferential extending portion 344a.

The U-phase radially extending portion 346a is continuous, with respect to the lower end of the U-phase circumferential extending portion 344a, in a manner so as to project out toward the X1 direction. The U-phase radially extending portion 346a extends along the radial direction. As shown in FIG. 8, the U-phase radially extending portion 346a and the U-phase bus rod 100a are aligned along the radial direction.

As can be understood from FIG. 3 and FIG. 4, a first through hole 348 of the U-phase tongue portion 342a overlaps with a first screw hole 350 of the connection terminal 328 that constitutes the U-phase conductive wire bundling portion 324a. A first screw 352 that is passed through the first through hole 348 is screwed into the first screw hole 350. On the other hand, a second through hole 354 of the U-phase radially extending portion 346a overlaps with a second screw hole 356 that is provided in the U-phase bus rod 100a. A second screw 358 that is passed through the second through hole 354 is screwed into the second screw hole 356. In accordance with the foregoing, the U-phase coil unit 320a and the U-phase bus rod 100a are electrically connected via the U-phase conductive bus bar 340a.

As shown in FIG. 3 and FIG. 8, the U-phase radially extending portion 346a includes an elastically deforming portion 359. In the illustrated example, the elastically deforming portion 359 is a curved portion that functions in the manner of a leaf spring. The elastically deforming portion 359 is capable of expanding and contracting when an external force is applied to the U-phase radially extending portion 346a.

The V-phase conductive bus bar 340b includes a V-phase radially extending portion 346b. The V-phase radially extending portion 346b comprises the first through hole 348 (refer to FIG. 9) and the second through hole 354. The V-phase conductive wire bundling portion 324b, the V-phase radially extending portion 346b, and the V-phase bus rod 100b are aligned along the radial direction. In this state, the first screw 352 that is passed through the first through hole 348 is screwed into the first screw hole 350 of the connection terminal 328 that constitutes the V-phase conductive wire bundling portion 324b. Further, the second screw 358 that is passed through the second through hole 354 is screwed into the second screw hole 356 that is provided in the V-phase bus rod 100b. In accordance with the foregoing, the V-phase coil unit 320b and the V-phase bus rod 100b are electrically connected via the V-phase conductive bus bar 340b.

The V-phase radially extending portion 346b comprises the elastically deforming portion 359 that is similar to that of the U-phase radially extending portion 346a. More specifically, the elastically deforming portion 359 in the V-phase conductive bus bar 340b is provided by bending the V-phase radially extending portion 346b.

The shape and the position of the W-phase conductive bus bar 340c have a relationship that is substantially a mirror image of the shape and the position of the U-phase conductive bus bar 340a. More specifically, the W-phase conductive bus bar 340c includes a W-phase tongue portion 342c, a W-phase circumferential extending portion 344c, and a W-phase radially extending portion 346c. The W-phase radially extending portion 346c and the W-phase bus rod 100c are aligned along the radial direction. In this state, the first screw 352 that is passed through the first through hole 348 of the W-phase tongue portion 342c is screwed into the first screw hole 350 of the connection terminal 328 that constitutes the W-phase conductive wire bundling portion 324c. Further, the second screw 358 that is passed through the second through hole 354 of the W-phase radially extending portion 346c is screwed into the second screw hole 356 that is provided in the W-phase bus rod 100c. In accordance with the foregoing, the W-phase coil unit 320c and the W-phase bus rod 100c are electrically connected via the W-phase conductive bus bar 340c.

The W-phase radially extending portion 346c includes the elastically deforming portion 359. More specifically, the elastically deforming portion 359 in the W-phase conductive bus bar 340c is provided by bending the W-phase radially extending portion 346c.

Moreover, hereinafter, the U-phase radially extending portion 346a, the V-phase radially extending portion 346b, and the W-phase radially extending portion 346c may be collectively referred to as “radially extending portions 346.”

FIG. 9 is an enlarged view of a main part in the vicinity of the connection portion accommodation chamber 316. As understood with reference to FIG. 8 and FIG. 9, when the first shaft end 58a of the rotating shaft 58 is viewed from the axial direction, the neutral point bus bar 330, the V-phase conductive wire bundling portion 324b, and the V-phase conductive bus bar 340b are aligned in this order from inwardly toward outwardly in the radial direction. Further, when the first shaft end 58a of the rotating shaft 58 is viewed from a direction perpendicular to the axial direction, the neutral point bus bar 330, the V-phase conductive wire bundling portion 324b, and the V-phase conductive bus bar 340b are aligned in this order from the intermediate portion 58m (or the second shaft end 58b) in the axial direction toward the first shaft end 58a.

As shown in FIG. 8, the rotating electric machine 16 comprises a conduction interrupting member 360. In the illustrated example, the conduction interrupting member 360 comprises a first insulating piece 362a, a second insulating piece 362b, and a third insulating piece 362c. The first insulating piece 362a is interposed between the U-phase tongue portion 342a and the rotating electric machine housing 18. The second insulating piece 362b is interposed between the U-phase radially extending portion 346a, the V-phase radially extending portion 346b, and the W-phase radially extending portion 346c, and the rotating electric machine housing 18. The third insulating piece 362c is interposed between the W-phase tongue portion 342c and the rotating electric machine housing 18. By means of the conduction interrupting member 360, the U-phase conductive bus bar 340a, the V-phase conductive bus bar 340b, and the W-phase conductive bus bar 340c, and the rotating electric machine housing 18 are electrically insulated from one another.

As shown in FIG. 2, the rotating electric machine 16 includes an insulating resin filler 364. The resin filler 364 is filled in a space between the outer circumferential surfaces of the respective inner circumferential protruding parts 308 of the first insulator 306a and the second insulator 306b, and the inner circumferential surface of the rotating electric machine housing 18. Accordingly, a portion of the resin filler 364 is disposed in the connection portion accommodation chamber 316. Therefore, the neutral point bus bar 330 is encapsulated in the resin filler 364. Further, the resin filler 364 is also fixed to a side outer surface of each of the connection terminals 328 of the U-phase conductive wire bundling portion 324a, the V-phase conductive wire bundling portion 324b, and the W-phase conductive wire bundling portion 324c.

As shown in FIG. 1, the connector portion 200 comprises the terminal casing 98, and the U-phase bus rod 100a, the V-phase bus rod 100b, and the W-phase bus rod 100c that are provided in the terminal casing 98, and three individual bus rod accommodation members 210. Hereinafter, mainly, a description will be given concerning the bus rod accommodation member 210 in which the V-phase bus rod 100b is accommodated.

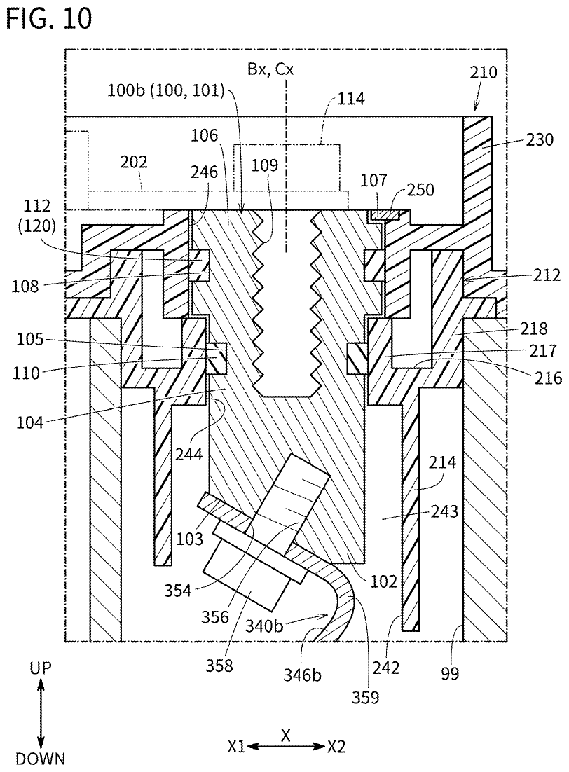

As can be understood from FIG. 1, FIG. 9, and FIG. 10, each of the three individual bus rod accommodation members 210 includes a main body member 212, and a cover member 230. As shown in FIG. 9 and FIG. 10, the main body member 212 is inserted into an installation space 99 that is formed in the terminal casing 98, and thereby closes the installation space 99. The cover member 230 is disposed externally of the terminal casing 98.

Each of the bus rod accommodation members 210 includes an accommodation hole 240 therein. The accommodation hole 240 has a first accommodation portion 242 and a second accommodation portion 244 in a tubular shaped portion 214 that is a part of the main body member 212, and has a third accommodation portion 246 in the cover member 230. In the illustrated example, the accommodation hole 240 extends along the radial direction. The second accommodation portion 244 is positioned more outwardly in the radial direction than the first accommodation portion 242 is. The diameter of the second accommodation portion 244 is slightly smaller than the diameter of the first accommodation portion 242.

As shown in detail in FIG. 10, the main body member 212 includes an annular concave portion 216 positioned on the outer circumference of the second accommodation portion 244, and an annular wall portion 218 positioned on the outer circumference of the annular concave portion 216. The main body member 212 further includes a flexible portion 217 positioned between the second accommodation portion 244 and the annular concave portion 216. When an external force is applied to the flexible portion 217 in a direction from the second accommodation portion 244 toward the annular concave portion 216, the external force is absorbed by a first seal ring 110. Accordingly, the influence of the external force is reduced. Further, the flexible portion 217 is capable of bending toward the annular concave portion 216.

The cover member 230 has the third accommodation portion 246. The diameter of the third accommodation portion 246 is slightly larger than the diameter of the second accommodation portion 244. The third accommodation portion 246 is continuous with the radially outward part of the second accommodation portion 244. In the cover member 230, a restricting member 250 is disposed on an outer edge of the third accommodation portion 246.

The cover member 230 further includes an insertion hole 232 therein. A connecting bolt 236 is passed through the insertion hole 232. The cover member 230 is connected to the terminal casing 98 by threading the connecting bolt 236 into a bolt hole 97 of the terminal casing 98.

The V-phase bus rod 100b comprises an inner side end 102, an intermediate portion 104, and an outer side end 106. The inner side end 102 is one end in the axial direction of the V-phase bus rod 100b, and faces inwardly in the radial direction. The inner side end 102 is accommodated in the first accommodation portion 242. In this manner, the first accommodation portion 242 is a portion of the accommodation hole 240 in which the inner side end 102 is accommodated.

The inner side end 102 includes an inclined surface 103. The inclined surface 103 is inclined toward the X1 direction, as it progresses from inwardly in the radial direction toward outwardly in the radial direction. The second screw hole 356 is formed in the inclined surface 103. More specifically, the V-phase radially extending portion 346b of the V-phase conductive bus bar 340b is inserted into the first accommodation portion 242, and is connected to the inclined surface 103. Moreover, a portion of an end part that faces inwardly in the radial direction of the tubular shaped portion 214 is inclined in matching relation to the inclined surface 103.

The intermediate portion 104 is in the middle in the axial direction of the V-phase bus rod 100b, and has a slightly larger diameter than that of the inner side end 102. The majority of the intermediate portion 104 is inserted into the second accommodation portion 244. The intermediate portion 104 has a first annular groove 105 on a side surface thereof, and the first seal ring 110 is accommodated in the first annular groove 105. The first seal ring 110 forms a seal between the side surface of the intermediate portion 104, and the inner surface of the second accommodation portion 244. Further, the first seal ring 110 serves to align the second accommodation portion 244 and the bus rods 100. As shown in the illustrated example, a portion of the intermediate portion 104 may be inserted into the first accommodation portion 242.

The outer side end 106 is another end in the axial direction of the V-phase bus rod 100b, and faces outwardly in the radial direction. The diameter of the outer side end 106 is slightly larger than the diameter of the second accommodation portion 244. Therefore, the radially inner side surface of the outer side end 106 abuts against an outer edge of the second accommodation portion 244. The outer side end 106 includes an arcuately shaped step portion 107, which is formed by cutting out in an arcuate shape a portion of the radially outer side surface.

The V-phase bus rod 100b includes a female thread portion 109 that extends from an upper surface of the outer side end 106 along the axial direction of the V-phase bus rod 100b. A connecting screw 114 is screwed into the female thread portion 109. The V-phase bus rod 100b, and an external terminal 202 (refer to FIG. 10) that constitutes an external connector 201 of an external device AU (refer to FIG. 1) are connected to each other by the connecting screw 114.

The outer side end 106 is accommodated in the third accommodation portion 246 of the cover member 230. In this instance, FIG. 10 shows a state prior to the V-phase bus rod 100b undergoing thermal expansion. As can be understood from FIG. 10, prior to the V-phase bus rod 100b undergoing thermal expansion, a small clearance is formed between the V-phase bus rod 100b and the inner surface of the accommodation hole 240. More specifically, the V-phase bus rod 100b is not restrained by the bus rod accommodation member 210. Further, the restricting member 250 separates away from the arcuately shaped step portion 107.

Accordingly, when the V-phase bus rod 100b undergoes thermal expansion, there is a possibility that relative displacement may occur with respect to the bus rod accommodation member 210. The direction of relative displacement is the axial direction of the V-phase bus rod 100b. Stated otherwise, the V-phase bus rod 100b is accommodated in the accommodation hole 240, in a state in which the V-phase bus rod 100b is capable of being displaced relative to the bus rod accommodation member 210 along the axial direction of the V-phase bus rod 100b. Moreover, it should be noted that the V-phase bus rod 100b is also capable of undergoing relative displacement along the radial direction of the V-phase bus rod 100b with respect to the bus rod accommodation member 210.

The rotating electric machine 16 comprises a centering member 120. In the illustrated example, the centering member 120 is a second seal ring 112 that is disposed in a second annular groove 108 in the outer side end 106. The side surface of the second seal ring 112, by elastically abutting against the inner surface of the third accommodation portion 246, places in alignment (centers) the central axis Bx of the V-phase bus rod 100b and the central axis Cx of the first accommodation portion 242. Moreover, it should be noted that the centering member 120 is not necessarily limited to being the second seal ring 112, but may be any member that is capable of bringing into alignment the central axis Bx of the V-phase bus rod 100b and the central axis Cx of the accommodation hole 240.

The rotating electric machine 16 has an annular space 243 therein. The annular space 243 is a space that is formed between the inner surface of the first accommodation portion 242 and the side surface of the inner side end 102. The annular space 243 communicates with the accommodation chamber 28 via an opening of the first accommodation portion 242. Accordingly, the annular space 243 is an open space.

The rotating electric machine 16 further includes the aforementioned restricting member 250. The restricting member 250 projects out from an outer edge of the third accommodation portion 246 toward the arcuately shaped step portion 107, and further, is positioned more radially outward than the arcuately shaped step portion 107.

The bus rod accommodation members 210 in which the U-phase bus rod 100a or the W-phase bus rod 100c is accommodated are also constituted in the same manner as described above. Accordingly, a description concerning these bus rod accommodation members 210 will be omitted.

Next, a description will be given concerning the gas turbine engine 14 shown in FIG. 1. Moreover, it should be noted that the configuration of the gas turbine engine 14, for example, is similar to the configuration shown in FIG. 7 of JP 2023-106078 A. Therefore, the description of the gas turbine engine 14 will be kept brief.

The gas turbine engine 14 is equipped with an engine housing 160. The engine housing 160 is connected to the rotating electric machine housing 18. The engine housing 160 includes a plurality of leg members 166. An air intake space is formed between the leg members 166.

As shown in FIG. 2, the gas turbine engine 14 is equipped with an output shaft 168. A non-illustrated compressor wheel and a non-illustrated turbine wheel are mounted radially outward of the output shaft 168. The output shaft 168 is connected to the rotating shaft 58. The compressor wheel and the turbine wheel are capable of rotating integrally together with the rotating shaft 58 and the output shaft 168. A portion of the air that is generated by the rotation of the compressor wheel is extracted, and is supplied to the rotating electric machine housing 18.

The combined motive power system 10 that is constituted as described above operates in the following manner.

As shown in FIG. 1, at first, the external connector 201 is electrically connected to the connector portion 200. The external connector 201 is a connector that is electrically connected to the external device AU. An example of the external device AU is a battery. In this state, the gas turbine engine 14 is started by driving the rotating electric machine 16 that is shown in FIG. 2. When the gas turbine engine 14 starts, the rotor 32 of the rotating electric machine 16 rotates due to the rotational driving force of the output shaft 168 of the gas turbine engine 14, and electricity is generated in the rotating electric machine 16. In accordance with this feature, the combined motive power system 10 is placed in operation. In the case that the external device AU is a battery, the battery is charged with the electrical power obtained from the rotating electric machine 16.

Accompanying the rotating shaft 58 undergoing rotation, vibrations are generated in the rotating shaft 58. A majority of the vibrations are blocked by the inner circumferential protruding part 308 of the first insulator 306a (the partition member 314) and the second insulator 306b. Therefore, the vibrations are suppressed from being transmitted to the outer circumference more so than the inner circumferential protruding part 308. In accordance with this feature, the neutral point bus bar 330, the plurality of conductive wires 322, the plurality of conductive wire bundling portions 324, the plurality of conductive bus bars 340, the plurality of terminals 101, and the like are protected from vibrations. Accordingly, disconnections or the like due to such vibrations can be avoided.

Further, the first insulator 306a and the neutral point bus bar 330 are sealed in the resin filler 364, and further, the resin filler 364 is fixed to a side outer surface of each of the connection terminals 328. More specifically, the neutral point bus bar 330, the U-phase conductive wire bundling portion 324a, the V-phase conductive wire bundling portion 324b, and the W-phase conductive wire bundling portion 324c are positioned and fixed in place by the resin filler 364. Therefore, disconnections or the like due to the vibrations can be further avoided.

During operation of the combined motive power system 10, air is supplied from the gas turbine engine 14 into the rotating electric machine housing 18. By means of this air, the rotating electric machine 16 is cooled. Further, the lubricating oil LO is supplied from the oil circulation supply device respectively to the first bearing 38, the second bearing 40, and the rotor internal flow path 63. The lubricating oil LO that is sprayed onto the first bearing 38 and the second bearing 40 lubricates the first bearing 38 and the second bearing 40. The lubricating oil LO flowing through the rotor internal flow path 63 cools the permanent magnets 61.

Furthermore, the heat that is generated in the U-phase coil unit 320a, the V-phase coil unit 320b, and the W-phase coil unit 320c is transferred via the resin filler 364 to the rotating electric machine housing 18. Therefore, a situation is avoided in which the permanent magnets 61 become high in temperature. For the reasons mentioned above, a situation is avoided in which the magnetic force of the permanent magnets 61 decreases.

A portion of the lubricating oil LO comes into contact with the first bearing 38, the second bearing 40, and the like, and bounces off therefrom. In the case that the lubricating oil LO that has bounced off splashes more outward than the rotor 32, each of the inner circumferential protruding parts 308 (the partition member 314) of the first insulator 306a and the second insulator 306b capture the lubricating oil LO, and thereby prevent the lubricating oil LO from splashing further outward. In accordance with this feature, in close proximity to the first shaft end 58a, a situation is avoided in which the U-phase conductive bus bar 340a, the V-phase conductive bus bar 340b, the W-phase conductive bus bar 340c, the first screws 352, the second screws 358, and the like become contaminated by the lubricating oil LO.

As can be understood from the above, the inner circumferential protruding part 308 of the first insulator 306a and the second insulator 306b functions as the partition member 314, and thereby can protect the electrical connections and the like from vibrations, and further, within the rotating electric machine housing 18, can keep the outer circumference thereof cleaner than the rotor 32.

As shown in FIG. 3 to FIG. 6, the neutral point bus bar 330 includes the first bus bar segment 332a to the fourth bus bar segment 332d. Therefore, as shown in FIG. 7, the neutral points of the respective individual single circuits CT1 are not electrically connected to each other. In accordance therewith, even in the case that the control frequency becomes high due to the rotor 32 rotating at a high speed, a situation is avoided in which a circulating electrical current occurs in the neutral point bus bar 330. Accordingly, losses in the rotating electric machine 16 can be reduced.

Further, the U-phase radially extending portion 346a and the U-phase bus rod 100a extend along the radial direction. In addition, the U-phase radially extending portion 346a and the U-phase bus rod 100a are aligned along the radial direction. The same applies concerning the V-phase radially extending portion 346b and the V-phase bus rod 100b, and the same applies concerning the W-phase radially extending portion 346c and the W-phase bus rod 100c. Therefore, the length of the radially extending portions 346 can be made as small as possible. In accordance therewith, the electrical resistance of the conductive bus bars 340 (the U-phase conductive bus bar 340a, the V-phase conductive bus bar 340b, and the W-phase conductive bus bar 340c) becomes small. Accordingly, the output of the rotating electric machine 16 is improved.

When the combined motive power system 10 is operated in the manner described above, the temperature of the U-phase bus rod 100a, the V-phase bus rod 100b, and the W-phase bus rod 100c (refer to FIG. 1) rises. In this instance, the air that is supplied to the accommodation chamber 28 of the rotating electric machine housing 18 flows into the annular space 243 shown in FIG. 10. The air acts as an insulator, and is unlikely to cause dielectric breakdown. Therefore, a situation is avoided in which electrical conduction takes place between the inner side end 102 and the tubular shaped portion 214. Further, the air inside the annular space 243 is replaced with the air inside the installation space 99. Therefore, the U-phase bus rod 100a, the V-phase bus rod 100b, and the W-phase bus rod 100c are cooled efficiently.

Accordingly, an increase in the electrical resistance of each of the U-phase bus rod 100a, the V-phase bus rod 100b, and the W-phase bus rod 100c is suppressed. Therefore, electrical power of a high output can be obtained from the rotating electric machine 16.

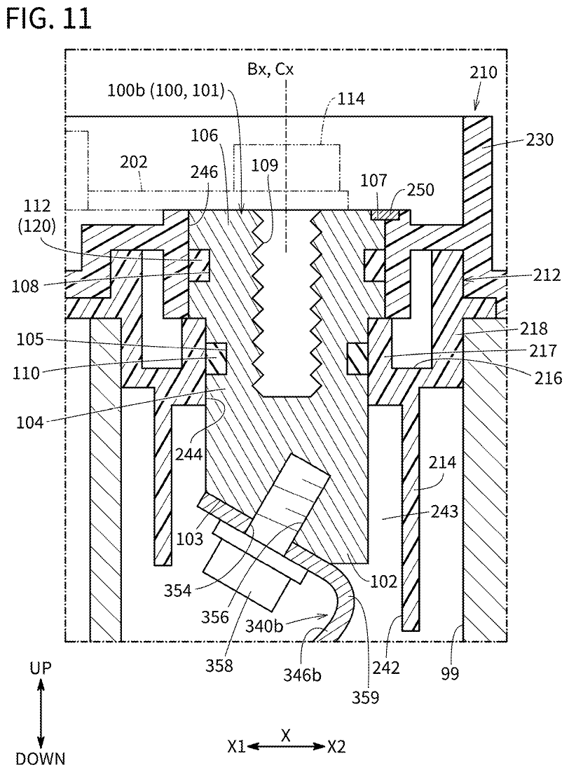

When the combined motive power system 10 is operated, as can be understood by comparing FIG. 10 and FIG. 11, the V-phase bus rod 100b undergoes thermal expansion. As shown in FIG. 11, the axial length of the V-phase bus rod 100b that has undergone thermal expansion becomes larger in comparison with that prior to the thermal expansion. Since the V-phase bus rod 100b is not constrained by the bus rod accommodation member 210, inside the accommodation hole 240, relative displacement takes place with respect to the bus rod accommodation member 210. Since the V-phase bus rod 100b is in a posture that extends along the radial direction, the direction of relative displacement of the V-phase bus rod 100b is restricted to the axial direction.

In this manner, the V-phase bus rod 100b that has undergone thermal expansion can be relatively displaced along the axial direction. Therefore, any stress that acts on the bus rod accommodation member 210 from the expanded V-phase bus rod 100b is alleviated.

In the case that the V-phase bus rod 100b has been relatively displaced in the axial direction, the restricting member 250 abuts against the inner bottom surface of the arcuately shaped step portion 107. Due to this abutment, the V-phase bus rod 100b is prevented from separating away from the accommodation hole 240. Further, in the case that the V-phase bus rod 100b is rotated, the restricting member 250 abuts against the inner side surface of the arcuately shaped step portion 107. Due to this abutment, the rotation of the V-phase bus rod 100b is stopped. In this manner, the restricting member 250 functions to prevent the V-phase bus rod 100b from coming out of the accommodation hole 240, and further, also functions to prevent the V-phase bus rod 100b from rotating.

In the case that the inner side end 102 of the V-phase bus rod 100b is relatively displaced inwardly in the radial direction, the elastically deforming portion 359 (refer to FIG. 9) of the V-phase conductive bus bar 340b contracts. Along therewith, any stress that is transmitted from the V-phase bus rod 100b to the V-phase conductive bus bar 340b is absorbed by the elastically deforming portion 359. On the other hand, in the case that the operation of the combined motive power system 10 is stopped, and the temperature of the V-phase bus rod 100b decreases, and further, the inner side end 102 of the V-phase bus rod 100b is relatively displaced inwardly and outwardly in the radial direction, the elastically deforming portion 359 of the V-phase conductive bus bar 340b expands. For the reasons mentioned above, a situation is avoided in which permanent deformation of the V-phase conductive bus bar 340b takes place. Further, the direction of relative displacement of the V-phase bus rod 100b is restricted to the axial direction of the V-phase bus rod 100b.

Further, it is expected that the diameter of the V-phase bus rod 100b will increase. In this case, the intermediate portion 104 of the V-phase bus rod 100b pushes the flexible portion 217 toward the outer circumferential side via the inner surface of the second accommodation portion 244.

In this instance, the first seal ring 110 is fitted into the first annular groove 105 that is formed in the intermediate portion 104 of the V-phase bus rod 100b. The first seal ring 110 absorbs the external force that acts on the main body member 212 from the V-phase bus rod 100b. Furthermore, the main body member 212 that constitutes the bus rod accommodation member 210 includes the annular concave portion 216 on the outer circumference of the flexible portion 217. Therefore, the flexible portion 217 is capable of bending toward the annular concave portion 216. For the reasons mentioned above, a situation in which the stress that is generated due to the thermal expansion of the V-phase bus rod 100b is transmitted to the annular wall portion 218 is suppressed.

Further, accompanying the diameter of the outer side end 106 of the V-phase bus rod 100b becoming larger, the clearance between the side surface of the outer side end 106 and the inner surface of the third accommodation portion 246 becomes smaller. More specifically, for example, a spaced state is maintained between the side surface of the outer side end 106 and the inner surface of the third accommodation portion 246. In this case, a situation is avoided in which stress is applied to the inner surface of the third accommodation portion 246 from the side surface of the outer side end 106. Even in the case that the side surface of the outer side end 106 lightly comes into contact with the inner surface of the third accommodation portion 246, the stress applied from the side surface of the outer side end 106 to the inner surface of the third accommodation portion 246 is small. Accordingly, the transmission of a large stress from the outer side end 106 to the cover member 230 is suppressed.

The second seal ring 112 that is disposed on the outer side end 106, when the outer side end 106 undergoes thermal expansion, is slightly reduced in diameter based on elastic deformation. Therefore, even after the thermal expansion of the V-phase bus rod 100b has occurred, the state in which the positions of the central axis Cx of the accommodation hole 240 and the central axis Bx of the V-phase bus rod 100b are aligned is maintained. Stated otherwise, any misalignment between the central axis Bx of the V-phase bus rod 100b and the central axis Cx of the accommodation hole 240 is avoided. Accordingly, loosening or the like of the connection between the V-phase conductive bus bar 340b and the V-phase bus rod 100b due to misalignment of these two central axes Bx and Cx is avoided. Concerning the foregoing, the same features also apply in relation to the U-phase bus rod 100a and the W-phase bus rod 100c. More specifically, according to the above-described configuration, it is possible to prevent large stresses from acting on the bus rod accommodation members 210 due to thermal expansion of the U-phase bus rod 100a, the V-phase bus rod 100b, and the W-phase bus rod 100c.

Next, a brief description will be given concerning the work of assembling the rotating electric machine system 12.

In the case of assembling the rotating electric machine system 12, an operator inserts any one of the U-phase bus rod 100a, the V-phase bus rod 100b, or the W-phase bus rod 100c into each of the accommodation holes 240 of the three individual bus rod accommodation members 210 (refer to FIG. 10). In this insertion, the inner side end 102 is passed through first from the third accommodation portion 246. By the lower surface of the outer side end 106 abutting against the outer edge of the second accommodation portion 244, the U-phase bus rod 100a, the V-phase bus rod 100b, and the W-phase bus rod 100c come to a stop.

During this insertion, the side surface of the second seal ring 112 elastically abuts against the inner surface of the third accommodation portion 246. In accordance therewith, the central axis Cx of each of the accommodation holes 240 and the central axis Bx of the U-phase bus rod 100a, the V-phase bus rod 100b, or the W-phase bus rod 100c are placed in alignment. In this manner, the second seal ring 112 functions as the centering member 120.

On the other hand, the operator, as shown in FIG. 4, winds the first U-phase conductive wire 322ua to the fourth U-phase conductive wire 322ud of the U-phase coil unit 320a respectively around the four individual teeth of the stator core 300. In accordance therewith, four individual ones of the U-phase coil portions 326a are provided. Moreover, a non-illustrated winding device is used for winding. Further, as the winding method, concentrated winding or distributed winding may be employed. Next, the operator, in the first U-phase conductive wire 322ua to the fourth U-phase conductive wire 322ud, connects the other ends thereof that are not bundled together as the U-phase conductive wire bundling portion 324a to the respective first connection portions 336a of the first bus bar segment 332a to the fourth bus bar segment 332d.

The operator, in the same manner as described above, provides four individual ones of the V-phase coil portions 326b, and connects the other ends of the first V-phase conductive wire 322va to the fourth V-phase conductive wire 322vd to the respective second connecting portions 336b of the first bus bar segment 332a to the fourth bus bar segment 332d. The operator, furthermore, provides four individual ones of the W-phase coil portions 326c, and connects the other ends of the first W-phase conductive wire 322wa to the fourth W-phase conductive wire 322wd to the respective third connecting portions 336c of the first bus bar segment 332a to the fourth bus bar segment 332d. In accordance therewith, the stator 34 is obtained. In this manner, the connection work of connecting the neutral point bus bar 330, and the U-phase coil unit 320a, the V-phase coil unit 320b, and the W-phase coil unit 320c is realized externally of the rotating electric machine housing 18.

Next, the operator inserts the stator 34 through the opening in the first housing end 20a of the rotating electric machine housing 18. By the stator core 300 abutting against a ring shaped step portion 23 inside the rotating electric machine housing 18, the stator 34 comes to a stop.

Next, the operator inserts the conduction interrupting member 360 (the first insulating piece 362a, the second insulating piece 362b, and the third insulating piece 362c) from the opening in the first housing end 20a, and furthermore, inserts the U-phase conductive bus bar 340a, the V-phase conductive bus bar 340b, and the W-phase conductive bus bar 340c from the opening in the first housing end 20a. Next, using the first screws 352, the operator respectively connects the connection terminals 328 of the U-phase conductive wire bundling portion 324a, the V-phase conductive wire bundling portion 324b, and the W-phase conductive wire bundling portion 324c to the U-phase conductive bus bar 340a, the V-phase conductive bus bar 340b, and the W-phase conductive bus bar 340c. Further, using the second screws 358, the operator respectively connects the U-phase conductive bus bar 340a, the V-phase conductive bus bar 340b, and the W-phase conductive bus bar 340c to the U-phase bus rod 100a, the V-phase bus rod 100b, and the W-phase bus rod 100c. The order of the connection by means of the first screws 352, and the connection by means of the second screws 358 may be in any arbitrary order. Moreover, it should be noted that at the point in time of carrying out the aforementioned connection work, the rotating shaft 58 has not yet been inserted into the rotating electric machine housing 18.

As shown in FIG. 9, when the first shaft end 58a of the rotating shaft 58 is viewed from the axial direction, the neutral point bus bar 330, the U-phase conductive wire bundling portion 324a, and the U-phase conductive bus bar 340a are aligned in this order from inwardly toward outwardly in the radial direction. Further, when the first shaft end 58a of the rotating shaft 58 is viewed from a direction perpendicular to the axial direction, the neutral point bus bar 330, the U-phase conductive wire bundling portion 324a, and the U-phase conductive bus bar 340a are aligned in this order from the intermediate portion 58m in the axial direction toward the first shaft end 58a. More specifically, the neutral point bus bar 330 and the U-phase conductive wire bundling portion 324a are arranged in a stepped manner, and further, the U-phase conductive wire bundling portion 324a and the U-phase conductive bus bar 340a are arranged in a stepped manner.

Accordingly, when the operator turns the first screw 352 and the second screw 358, the neutral point bus bar 330 does not become an obstacle to such turning. When the operator turns the second screw 358, the U-phase conductive wire bundling portion 324a does not become an obstacle to such turning. In addition, the U-phase bus rod 100a and the U-phase radially extending portion 346a extend along the radial direction, and further, are aligned along the radial direction. Accordingly, the operator is capable of easily turning the first screw 352 and the second screw 358. More specifically, the operator is capable of easily connecting the U-phase coil unit 320a and the U-phase bus rod 100a.

Concerning the foregoing, the same features also apply in relation to the V-phase conductive wire bundling portion 324b and the V-phase conductive bus bar 340b, and the W-phase conductive wire bundling portion 324c and the W-phase conductive bus bar 340c. More specifically, by disposing the electrical connection portion in the manner described above, the connection work of connecting the plurality of coil units 320 and the neutral point bus bar 330 becomes easier, and the connection work of connecting the plurality of coil units 320 and the plurality of terminals 101 becomes easier.

Next, with respect to the space that is formed between each of the inner circumferential protruding parts 308 of the first insulator 306a and the second insulator 306b, and the inner circumferential surface of the rotating electric machine housing 18, the operator fills the space with the insulating fluid resin from the opening of the first housing end 20a. In the first bus bar segment 332a to the fourth bus bar segment 332d, the plate thickness directions thereof are aligned with the radial direction, and further, the widthwise directions thereof are parallel to the axial direction. Therefore, the flow resistance of the neutral point bus bar 330 with respect to the fluid resin becomes small. More specifically, the fluid resin flows quickly. As shown in FIG. 2 and FIG. 9, by the fluid resin hardening, the resin filler 364 is formed.

As shown in FIG. 2, thereafter, the operator accommodates the rotor 32 and the circumferential members in the hollow interior of the stator 34, and furthermore, closes the opening of the first housing end 20a with the first sub-housing 21. In accordance therewith, the rotating electric machine system 12 is obtained. Thereafter, by the output shaft 168 of the gas turbine engine 14 being coupled to the second shaft end 58b of the rotating shaft 58, the combined motive power system 10 shown in FIG. 1 is obtained.

The present embodiment possesses the following advantageous effects.

As can be understood from FIG. 9, when the rotating electric machine 16 is viewed along the axial direction from the first shaft end 58a of the rotating shaft 58, the neutral point bus bar 330 (the first bus bar segment 332a to the fourth bus bar segment 332d), the plurality of conductive wire bundling portions 324 (the U-phase conductive wire bundling portion 324a, the V-phase conductive wire bundling portion 324b, and the W-phase conductive wire bundling portion 324c), and the plurality of conductive bus bars 340 (the U-phase conductive bus bar 340a, the V-phase conductive bus bar 340b, and the W-phase conductive bus bar 340c) are aligned in this order from inwardly toward outwardly of the rotating shaft 58. Further, when the rotating electric machine 16 is viewed from a direction perpendicular to the axial direction, the neutral point bus bar 330, the plurality of conductive wire bundling portions 324, and the plurality of conductive bus bars 340 are aligned in this order from a direction facing the intermediate portion 58m in the axial direction toward a direction facing the first shaft end 58a.

More specifically, the neutral point bus bar 330, the plurality of conductive wire bundling portions 324, and the plurality of conductive bus bars 340 are arranged in a stepped manner. Therefore, it is easy to form an electrical connection from the side of the intermediate portion 58m in the axial direction (or the second shaft end 58b) toward the first shaft end 58a. In accordance therewith, the working efficiency and the reliability in assembling the rotating electric machine system 12 is improved.

As shown in FIG. 3 to FIG. 6, the neutral point bus bar 330 includes the first bus bar segment 332a to the fourth bus bar segment 332d. More specifically, the neutral point bus bar 330 is divided into the plurality of bus bar segments 332. As can be understood with further reference to FIG. 7, a situation is avoided in which a circulating electrical current flows through the neutral point bus bar 330. Accordingly, losses in the rotating electric machine 16 are reduced.

The rotating electric machine 16 includes the insulating resin filler 364. The neutral point bus bar 330 is encapsulated in the resin filler 364. Further, the resin filler 364 is also fixed to a side outer surface of each of the connection terminals 328 of the U-phase conductive wire bundling portion 324a, the V-phase conductive wire bundling portion 324b, and the W-phase conductive wire bundling portion 324c.

In this manner, the neutral point bus bar 330, the U-phase conductive wire bundling portion 324a, the V-phase conductive wire bundling portion 324b, and the W-phase conductive wire bundling portion 324c are positioned and fixed in place. Furthermore, since the resin filler 364 covers the entirety of the stator core 300, the stator 34 is positioned and fixed in place. Accordingly, the electrical connection portion is less susceptible to the influence of vibrations of the rotating shaft 58. Further, since the heat from the plurality of coil units 320 is transferred via the resin filler 364 to the rotating electric machine housing 18, the permanent magnets 61 of the rotor 32 are prevented from becoming high in temperature. Accordingly, a situation is avoided in which the magnetic force of the permanent magnets 61 decreases.

The neutral point bus bar 330 includes the plate-shaped main body portion 334 that extends in the longitudinal direction along the circumferential direction of the rotating shaft 58. The widthwise direction of the main body portion 334 (the direction perpendicular to the plate thickness direction and the longitudinal direction) is parallel to the axial direction.

Therefore, when a fluid resin that serves as the resin filler 364 is filled into the rotating electric machine housing 18, the flow resistance of the neutral point bus bar 330 with respect to the fluid resin becomes small. Accordingly, the fluid resin can be filled quickly.

The rotating electric machine 16 comprises the partition member 314 that is interposed between the rotating shaft 58 and the neutral point bus bar 330 in the radial direction. In the present embodiment, the partition member 314 is the first insulator 306a. More specifically, the inner circumferential protruding part 308 of the first insulator 306a separates the rotating shaft 58 and the neutral point bus bar 330.

In accordance with such a configuration, the transmission of vibrations from the rotating shaft 58 to the electrical connection portion is suppressed. Further, in the case that the lubricating oil LO that is supplied to the first bearing 38 and the second bearing 40 splashes outwardly from the rotor 32, the lubricating oil LO is captured. Therefore, scattering of the lubricating oil LO further outward than the inner circumferential protruding part 308 is prevented. Accordingly, for example, a situation is avoided in which the first screws 352, the plurality of conductive bus bars 340, and the second screws 358 become contaminated by the lubricating oil LO.

Further, since the first insulator 306a that is mounted on the stator core 300 functions as the partition member 314, an increase in the number of parts of the rotating electric machine 16 is avoided.

The rotating electric machine 16 comprises the conduction interrupting member 360. The conduction interrupting member 360 is interposed between the U-phase conductive bus bar 340a, the V-phase conductive bus bar 340b, and the W-phase conductive bus bar 340c, and the rotating electric machine housing 18, and thereby serves to electrically insulate the plurality of conductive bus bars 340 and the rotating electric machine housing 18.

Accordingly, the occurrence of a short circuit between the U-phase conductive bus bar 340a, the V-phase conductive bus bar 340b, and the W-phase conductive bus bar 340c, and the rotating electric machine housing 18 is avoided.

The rotating electric machine 16 is a three-phase rotating electric machine, and the U-phase conductive bus bar 340a, the V-phase conductive bus bar 340b, and the W-phase conductive bus bar 340c respectively include the U-phase radially extending portion 346a, the V-phase radially extending portion 346b, and the W-phase radially extending portion 346c. The U-phase radially extending portion 346a, the V-phase radially extending portion 346b, and the W-phase radially extending portion 346c extend respectively along the radial direction. Furthermore, the U-phase radially extending portion 346a and the U-phase bus rod 100a are aligned along the radial direction. Similarly, the V-phase radially extending portion 346b and the V-phase bus rod 100b are also aligned along the radial direction, and the W-phase radially extending portion 346c and the W-phase bus rod 100c are also aligned along the radial direction.

In accordance with such a configuration, the length of the radially extending portions 346 can be reduced. Therefore, the electrical resistance between the U-phase conductive wire bundling portion 324a and the U-phase bus rod 100a can be made as small as possible. The same features also apply in relation to the V-phase conductive wire bundling portion 324b and the V-phase bus rod 100b, and the W-phase conductive wire bundling portion 324c and the W-phase bus rod 100c.

Each of the bus rod accommodation members 210 includes the accommodation hole 240 therein. The bus rods 100 (the U-phase bus rod 100a, the V-phase bus rod 100b, or the W-phase bus rod 100c) are accommodated in the accommodation holes 240 in a state in which they are capable of being displaced relative to the bus rod accommodation members 210. The direction of relative displacement of the bus rods 100 is along the axial direction of the bus rods 100.

When the bus rods 100 thermally expand accompanying the operation of the rotating electric machine 16, the bus rods 100 undergo relative displacement within the accommodation hole 240 along the axial direction. Due to such relative displacement, any stress that acts on the bus rod accommodation members 210 from the expanded bus rods 100 is alleviated.

The rotating electric machine 16 includes the restricting member 250. By the restricting member 250 pressing the bus rods 100, the bus rods 100 are prevented from separating away from the accommodation hole 240.

Each of the bus rod accommodation members 210 includes the tubular shaped portion 214. The tubular shaped portion 214 includes the first accommodation portion 242 as a part of the accommodation hole 240. The first accommodation portion 242 accommodates the inner side end 102, which is one end in the axial direction of the bus rods 100. The annular space 243 is formed between the side surface of the inner side end 102, and the inner surface of the first accommodation portion 242.

The air that flows into the annular space 243 serves as an insulator. Accordingly, electrical conduction between the bus rods 100 and the bus rod accommodation members 210 is avoided. Further, accompanying the air in the annular space 243 being replaced with the air in the accommodation chamber 28, the bus rods 100 are cooled efficiently. Accordingly, an increase in the electrical resistance of the bus rods 100 is suppressed.

The conductive bus bars 340 that electrically connect each of the coil portions 326 and the bus rods 100 comprise the radially extending portions 346. The respective radially extending portions 346 and the bus rods 100 are aligned along the radial direction of the rotating shaft 58. In this state, the radially extending portions 346 are inserted into the accommodation holes 240, and are connected to the inner side end 102 of the bus rods 100.

In accordance with such a configuration, the length of the U-phase radially extending portion 346a, the V-phase radially extending portion 346b, and the W-phase radially extending portion 346c can be made as short as possible. Accordingly, the electrical resistance of the conductive bus bars 340 is reduced. Consequently, the size and scale of the rotating electric machine housing 18 can be reduced.

Each of the radially extending portions 346 includes the elastically deforming portion 359 that is capable of expanding or contracting along the radial direction when the bus rods 100 undergo relative displacement.

In this case, the direction in which the bus rods 100 undergo relative displacement can be restricted to the radial direction of the rotating shaft 58.

The rotating electric machine 16 comprises the centering member 120. By the centering member 120, the central axis Bx of the bus rods 100 is aligned with the central axis Cx of the accommodation hole 240.

By the centering member 120, at a time prior to and after the expansion of the bus rods 100, a situation can be avoided in which the central axis Bx of each of the bus rods 100 becomes misaligned with the central axis Cx of each of the accommodation holes 240. Therefore, loosening of the connection between the conductive bus bars 340 and the bus rods 100 can be avoided.

The bus rods 100 are in a posture in which the axis of the bus rods 100 extends along the radial direction of the rotating shaft 58.

Therefore, in the work of assembling the rotating electric machine system 12, the bus rods 100 and the radially extending portions 346 of the conductive bus bars 340 can be easily connected.

In relation to the above-described embodiment, the following supplementary notes are further disclosed.

### Supplementary Note 1

The rotating electric machine system (12) of the present disclosure is equipped with the rotating electric machine (16) provided with the rotor (32) including the rotating shaft (58), the stator (34) including the plurality of coil units (320), and the connector (110) including the plurality of terminals (101) configured to electrically connect the plurality of coil units to the external device (AU), and the rotating electric machine housing (18) on which the rotating shaft is rotatably supported, wherein the stator includes the stator core (300), each of the plurality of coil units comprises the plurality of coil portions (326) formed by winding the plurality of conductive wires (322) respectively around the stator core, and the conductive wire bundling portion (324) in which the end parts of the plurality of conductive wires are bundled together and connected, the rotating electric machine comprises the neutral point bus bar (330) configured to be electrically connected to the neutral points of the plurality of coil units, and the plurality of conductive bus bars (340) configured to electrically connect, respectively, the plurality of conductive wire bundling portions and the plurality of terminals, and the neutral point bus bar, the plurality of conductive wire bundling portions, and the plurality of conductive bus bars, when one end part in the axial direction of the rotating shaft is viewed from the axial direction, are aligned in this order from inwardly toward outwardly in the radial direction of the rotating shaft, and further, when the rotating shaft is viewed from a direction perpendicular to the axial direction, are aligned in this order in the axial direction from the intermediate portion (58m) of the rotating shaft in the axial direction toward the one end part.

In accordance with such a configuration, the neutral point bus bar and the plurality of conductive wire bundling portions are arranged in a stepped manner, and further, the plurality of conductive wire bundling portions and the plurality of conductive bus bars are arranged in a stepped manner. Therefore, the work of forming the electrical connection portion is easy. In accordance therewith, the working efficiency and the reliability in assembling the rotating electric machine system is improved.

### Supplementary Note 2

In the rotating electric machine system according to Supplementary Note 1, the neutral point bus bar may include the plurality of bus bar segments (332), and the number of the plurality of bus bar segments may be the same as the number of the plurality of conductive wires possessed by each of the plurality of coil units.

In accordance with such a configuration, a situation is avoided in which a circulating electrical current flows through the neutral point bus bar. Accordingly, losses in the rotating electric machine are reduced.

### Supplementary Note 3

In the rotating electric machine system according to Supplementary Note 1 or 2, the rotating electric machine may include the insulating resin filler (364) configured to encapsulate the neutral point bus bar, and which is fixed to the side outer surfaces of the plurality of conductive wire bundling portions.

In accordance with such a configuration, the electrical connection portion is less susceptible to the influence of vibrations of the rotating shaft. Accordingly, for example, breakage of the plurality of conductive wires can be avoided. Further, heat that is generated in the plurality of coil units can be quickly transferred via the resin filler to the rotating electric machine housing.

### Supplementary Note 4

In the rotating electric machine system according to Supplementary Note 3, the neutral point bus bar may include the plate shaped main body portion (334) configured to extend longitudinally along the circumferential direction of the rotating shaft, and in the main body portion, the widthwise direction perpendicular to the plate thickness direction and the longitudinal direction may be parallel to the axial direction.

In accordance with such a configuration, when the fluid resin that serves as the resin filler is filled into the rotating electric machine housing, the flow resistance of the neutral point bus bar with respect to the fluid resin becomes small.

### Supplementary Note 5

In the rotating electric machine system according to any one of Supplementary Notes 1 to 4, the rotating electric machine may include the partition member (314) interposed between the rotating shaft and the neutral point bus bar in the radial direction, and configured to separate the rotating shaft and the neutral point bus bar.

In accordance with such a configuration, a situation is avoided in which the plurality of conductive bus bars and the like become soiled or contaminated. Furthermore, the transmission of vibrations from the rotating shaft to the electrical connection portion is suppressed.

### Supplementary Note 6

In the rotating electric machine system according to Supplementary Note 5, the partition member may include the insulator (306a) interposed between the stator core and the conductive wires.

In accordance with such a configuration, an increase in the number of component parts is avoided.

### Supplementary Note 7

In the rotating electric machine system according to any one of Supplementary Notes 1 to 6, the rotating electric machine may include the conduction interrupting member (360) that is interposed between the plurality of conductive bus bars and the rotating electric machine housing, and configured to electrically insulate the plurality of conductive bus bars and the rotating electric machine housing.

In accordance with such a configuration, it is possible to prevent a short circuit from occurring between the plurality of conductive bus bars and the rotating electric machine housing.

### Supplementary Note 8

In the rotating electric machine system according to any one of Supplementary Notes 1 to 7, the plurality of terminals may include the U-phase terminal (100a), the V-phase terminal (100b), and the W-phase terminal (100c), the plurality of coil units may include the U-phase coil unit (320a), the V-phase coil unit (320b), and the W-phase coil unit (320c), the U-phase coil unit may include the U-phase coil portion (326a), and the U-phase conductive wire bundling portion (324a), the V-phase coil unit may include the V-phase coil portion (326b), and the V-phase conductive wire bundling portion (324b), the W-phase coil unit may include the W-phase coil portion (326c), and the W-phase conductive wire bundling portion (324c), the plurality of conductive bus bars may include the U-phase conductive bus bar (340a), the V-phase conductive bus bar (340b), and the W-phase conductive bus bar (340c), and the U-phase conductive wire bundling portion may be electrically connected via the U-phase conductive bus bar to the U-phase terminal, the V-phase conductive wire bundling portion may be electrically connected via the V-phase conductive bus bar to the V-phase terminal, and the W-phase conductive wire bundling portion may be electrically connected via the W-phase conductive bus bar to the W-phase terminal.

In this manner, the three-phase rotating electric machine can be constituted.

### Supplementary Note 9

In the rotating electric machine system according to Supplementary Note 8, the U-phase conductive bus bar, the V-phase conductive bus bar, and the W-phase conductive bus bar may respectively include the U-phase radially extending portion (346a), the V-phase radially extending portion (346b), and the W-phase radially extending portion (346c) configured to extend along the radial direction, the U-phase radially extending portion and the U-phase terminal may be aligned along the radial direction, the V-phase radially extending portion and the V-phase terminal may be aligned along the radial direction, and the W-phase radially extending portion and the W-phase terminal may be aligned along the radial direction.

Since the radially extending portion of each of the phases and the terminal of each of the phases are aligned along the radial direction, the length of the radially extending portion of each of the phases can be reduced. Therefore, the electrical resistance between each of the conductive wire bundling portions and each of the terminals can be made as small as possible.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of the operations and the order of the processes are illustrated as examples, and the present invention is not necessarily limited to these features. The same also applies to cases in which numerical values or mathematical expressions are used in the description of the aforementioned embodiments.

1. A rotating electric machine system comprising:
a rotating electric machine comprising a rotor including a rotating shaft, a stator including a plurality of coil units, and a connector including a plurality of terminals configured to electrically connect the plurality of coil units to an external device; and
a rotating electric machine housing on which the rotating shaft is rotatably supported;
wherein the stator comprises a stator core;
each of the plurality of coil units comprises a plurality of coil portions formed by winding a plurality of conductive wires respectively around the stator core, and a conductive wire bundling portion in which end parts of the plurality of conductive wires are bundled together and connected;
the rotating electric machine comprises a neutral point bus bar configured to be electrically connected to neutral points of the plurality of coil units, and a plurality of conductive bus bars configured to electrically connect, respectively, the plurality of conductive wire bundling portions and the plurality of terminals; and
the neutral point bus bar, the plurality of conductive wire bundling portions, and the plurality of conductive bus bars, when one end part in the axial direction of the rotating shaft is viewed from the axial direction, are aligned in this order from inwardly toward outwardly in the radial direction of the rotating shaft, and further, when the rotating shaft is viewed from a direction perpendicular to the axial direction, are aligned in this order in the axial direction from an intermediate portion of the rotating shaft in the axial direction toward the one end part.

2. The rotating electric machine system according to claim 1, wherein the neutral point bus bar comprises a plurality of bus bar segments, and a number of the plurality of bus bar segments is same as a number of the plurality of conductive wires possessed by each of the plurality of coil units.

3. The rotating electric machine system according to claim 1, wherein the rotating electric machine comprises an insulating resin filler configured to encapsulate the neutral point bus bar, and which is fixed to side outer surfaces of the plurality of conductive wire bundling portions.

4. The rotating electric machine system according to claim 3, wherein the neutral point bus bar comprises a plate shaped main body portion configured to extend longitudinally along a circumferential direction of the rotating shaft, and in the main body portion, a widthwise direction perpendicular to a plate thickness direction and the longitudinal direction is parallel to the axial direction.

5. The rotating electric machine system according to claim 1, wherein the rotating electric machine comprises a partition member interposed between the rotating shaft and the neutral point bus bar in the radial direction, and configured to separate the rotating shaft and the neutral point bus bar.

6. The rotating electric machine system according to claim 5, wherein the partition member comprises an insulator interposed between the stator core and the conductive wires.

7. The rotating electric machine system according to claim 1, wherein the rotating electric machine comprises a conduction interrupting member interposed between the plurality of conductive bus bars and the rotating electric machine housing, and configured to electrically insulate the plurality of conductive bus bars and the rotating electric machine housing.

8. The rotating electric machine system according to claim 1, wherein:
the plurality of terminals comprises a U-phase terminal, a V-phase terminal, and a W-phase terminal;
the plurality of coil units comprises a U-phase coil unit, a V-phase coil unit, and a W-phase coil unit;
the U-phase coil unit comprises a U-phase coil portion, and a U-phase conductive wire bundling portion;
the V-phase coil unit comprises a V-phase coil portion, and a V-phase conductive wire bundling portion;
the W-phase coil unit comprises a W-phase coil portion, and a W-phase conductive wire bundling portion;
the plurality of conductive bus bars comprises a U-phase conductive bus bar, a V-phase conductive bus bar, and a W-phase conductive bus bar; and
the U-phase conductive wire bundling portion is electrically connected via the U-phase conductive bus bar to the U-phase terminal, the V-phase conductive wire bundling portion is electrically connected via the V-phase conductive bus bar to the V-phase terminal, and the W-phase conductive wire bundling portion is electrically connected via the W-phase conductive bus bar to the W-phase terminal.

9. The rotating electric machine system according to claim 8, wherein:
the U-phase conductive bus bar, the V-phase conductive bus bar, and the W-phase conductive bus bar respectively comprise a U-phase radially extending portion, a V-phase radially extending portion, and a W-phase radially extending portion configured to extend along the radial direction;
the U-phase radially extending portion and the U-phase terminal are aligned along the radial direction;
the V-phase radially extending portion and the V-phase terminal are aligned along the radial direction; and
the W-phase radially extending portion and the W-phase terminal are aligned along the radial direction.
